(19) United States
(12) Patent Application Publication
(10) Pub. No.: US 2005/0268544 A1
(43) Pub. Date: Dec. 8, 2005

(54) Plant protection device and method

(76) Inventor: James Anthony Maffei, Sebago, ME (US)

Correspondence Address: BOHAN, MATHERS & ASSOCIATES, LLC, PO BOX 17707, PORTLAND, ME, 04112-8707, US

(21) Appl. No.: 11/199,035

(22) Filed: Aug. 8, 2005

Related U.S. Application Data
(63) Continuation-in-part of application No. 10/661,301, filed on Sep. 12, 2003, now abandoned.
(60) Provisional application No. 60/410,401, filed on Sep. 13, 2002.

(51) Int. Cl. A01G 13/02

(52) U.S. Cl. 47/29.1

(57) ABSTRACT

A protective enclosure for protecting garden plants against frost and other environmental hazards. The enclosure consists of support arches over which a protective cover is deployed. The cover is held in place by elastic hold-downs strung across the outside of the cover at each arch. Each arch presents to the hold-down a concave shape that receives and stabilizes the hold-down. The cover is translucent to sunlight and may include two types of material, one impervious to wind and rain, the other a mesh transparent to wind and rain. The cover or portions of it may be polarized to enhance or retard the pass-through of certain spectra of light. Access to plants is gained by lifting and bunching up the side portions of the cover, which are easily placed in a closed position again when access is no longer necessary.

### BACKGROUND OF THE INVENTION

1. Field of Invention

This invention relates to gardening. More particularly, it relates to devices and methods for protecting garden plants against weather conditions and insects adverse to the healthy growth of such plants. More particularly still, this invention relates to covers used for protecting row-planted garden plants and to the use of such covers.

2. Description of Prior Art

Home gardening and small-scale gardening to supply roadside stands constitute widespread and generally enjoyable activities in the temperate climate zones of the world. Where it is undertaken, there are a number of natural conditions that limit its effectiveness if not to say enjoyableness. Of these, late Spring frost and early Autumn frost rank very high in their impact, both having the capability of destroying an entire crop overnight. Additional perennial hazards include wind, hail, insects, birds, and inappropriate rainfall, whether excessive or deficient. In addition, there are arable areas of the country where the average growing season is too short for most plants of interest. Even though the frost-free season is sufficiently long, the period during which temperatures are actually high enough to stimulate the growth of plants is not. This is commonly the case on islands off the Northeastern United States and the Maritime Provinces of Canada. Although greenhouses provide good protection from these hazards and can extend the effective growing season, they can be impractical for small-scale growers. Also, they are not necessary for much of the growing season in the warmer parts of the temperate zone.

Various approaches have been undertaken in an attempt to produce protective devices that are less permanent and less expensive than greenhouses. One, referred to as the “Water Fence”, is a cellular, multi-tube, transparent plastic structure, designed to be filled with water and deployed over the plants to be protected. The specific heat of the water modulates temperature fluctuations at the position of the plants themselves, thus protecting them from frost, provided that the ambient air temperature does not fall far below freezing for extended times. This Water Fence is translucent so that it can be, and is intended to be, left in place during the days as well as frosty nights. While the Water Fence offers protection from frost and wind, it is not effective against high winds, hail, and insect infestation. Also, it is intended to be used at the start of a growing season and the plants quickly outgrow it. Additionally, it is cumbersome to deploy, and tends to break easily because of the weight of the water it has to support. Also, the water it contains as an intrinsic feature is susceptible to algae growth, which increases the opacity of the cover, with the obvious detrimental consequences for the growth of the plants it is protecting. In general, any of the prior-art covers that are sufficient to give frost protection and wind protection tend to reduce the solar radiation available to the plant to a degree that is detrimental to plant growth. Thus, there is a great incentive not to leave these covers on during periods when frost is not a concern. Thus, they are limited in the protection they provide against insects and many other ambient hazards.

Then there is the Garden Umbrella, which, as the name implies, is designed to be placed directly over one or a few plants, like an umbrella. Although it is easy to deploy, a large number must be used to protect an entire garden. Also, though it retards the radiation from the plants that can lead to frost on cold, clear nights, it is not that good at frost protection, since it leaves the plants in contact with ambient air. Also it does nothing to guard against insects and very little to protect against wind. Indeed, because of its structure, it is itself vulnerable to high winds.

There is an entire class of plant protectors that are categorized as “row protectors,” since they are designed to cover a linear array of plants, such as grow in one or several adjoining rows in a garden. They all generally take the form of an extended, translucent plastic sheet laid over support arches that are lined up along and span the row to be protected. These row protectors have the advantage of being more portable and flexible than greenhouses. Nevertheless, those of which the present inventor has knowledge have several serious drawbacks. Some of them have supports made of metal, which heats up due to insulation, with the result that the elevated temperatures accelerate the deterioration of the plastic cover. Also, the metal supports rust and abrade the covers, and generally become unsightly over time. When the supports are wood, the drawbacks are rot and loss of strength as time passes. The biggest criticism of the supports of traditional row covers is that they do nothing but support the plastic cover. They do not contribute to the security of the system, and as a consequence, additional components have to be added to it, reducing the flexibility and introducing drawbacks of their own. In particular, to ensure that the cover remains on the supports under windy conditions, the prior-art row cover systems usually affix the covers to the supports by staples or other affixing means deployed at specific locations on the supports. Unfortunately, this approach is vulnerable to failure in moderate to high winds, since the spatial localization of the affixing technique causes enhanced stress at those points. This results in a tearing of the plastic cover and potentially a sudden and complete ripping away, that is, failure, of the cover.

Another or an additional approach to holding down the cover is to attach weights to the cover's outer longitudinal edges. The weight is distributed longitudinally and, if used by itself, does serve to delocalize the stress applied to the cover during windy conditions. See, for example, the system taught by Robinson (U.S. Pat. No. 4,856,228). Robinson describes an inflatable tunnel for row crops, wherein the cover is held up by air pressure within inflatable ribs that are integral to the cover. Water-filled ballasts serve as the longitudinal weights. Unfortunately, because of the unitary nature of the Robinson device, the cover cannot easily be removed for venting, plant maintenance, or harvesting.

The Floating Row Cover avoids the problems associated with the support arches of the previously described row covers. It consists of a translucent plastic sheet draped directly across a bed of plants. While it provides some frost protection, it does not protect against wind. Further, it inhibits plant growth because it rests directly on the plants. Additionally, routine tending of the plants, such as should be done in all gardens, is burdensome because the device needs to be lifted from, and then re-secured to, the ground each time access to the plants is desired or necessary.

Koziol (U.S. Pat. No. 3,812,616) and Anderson (U.S. Pat. No. 4,665,646) each describe a protective enclosure that includes a series of arched supports extending the length of a row and a translucent plastic cover draped over the supports. The cover of both the Koziol and Anderson enclosures is reversibly affixed to the supports by a series of clamps located at the bottom of the individual arches. With the clamps released, the cover can be rolled along the supports to the top where a retaining member can be inserted to hold the cover in place. The cover is intended to be used in the early stages of plant development and then removed, but the supports are then intended to be stacked around each plant so as to provide continued structural support to the plant. A disadvantage of the systems of Anderson and Koziol is the amount of effort necessary to release the cover and secure it to the supports, as needs to be done each time one wishes to directly access the plants. Also, during the period that the cover is lifted, for venting or otherwise, the plants are exposed to insects and birds. Another disadvantage is that the cover is affixed to the supports at specific points, which concentrates the stress arising from wind and rain. With the stress thus concentrated, the cover is highly susceptible to tearing, and thus failing, potentially abruptly and completely.

Therefore, what is needed are a row cover device and method that do not require localized affixing of the cover nor weights at the edges of the cover to hold the cover down. What is further needed is such a device that maintains its structural integrity in the worst storms reasonably expected and that provides differing transparencies to sun and wind, as the gardener desires. What is yet further needed is such a device that affords the gardener easy access to the plants and allows the installation of a humidity-control system within the cover. In general, what is needed is such a device that is useful not only for providing protection against frost, but also throughout the frost-free growing season for providing protection from other hazards, while not interfering with the continued natural growth of the plants. Finally, what is needed is such a row cover that vents moisture and heat while protecting against insects.

### SUMMARY OF THE INVENTION

For the reasons mentioned above, it is an object of the present invention to provide protection for garden plants against the hazards of the environment, including, but not limited to, frost, wind, insects, high temperatures, flood, and drought. A further object is to provide this protection with a system that is not susceptible to destruction by high winds and heavy rains. A yet further object of the present invention is to provide the stated protection without unduly limiting the gardener's access to the plants being protected. A still further object of the present invention is to permit a modulated exposure of the plants to the immediate environment, so that when maximum protection against frost is not needed, the plants can benefit from closer contact with sunlight and the air surrounding the cover.

The present invention meets its stated objects by a new approach to the support end of the row protection cover. Arch supports are designed to hold down the cover, as well as support it. These arch supports or arches are semi-circular plastic elements present in certain prior-art systems. Ideally, the arches are extruded PVC elements that provide the necessary support, but also have a degree of flexibility, although any suitable material may be used. The arches present a concave groove along their outward facing surfaces. In deploying the system of the present invention, these arches are set out along the row to be protected. The ends of the arches may be placed directly in the ground, or may be inserted into tubes that have been placed in the ground. The cover (which may include more than one component sheet) is draped along and across the arches and held in place by an elastic hold-down. The hold-down is an elastic cord element with two ends. The hold-down is stretched across the surface of the cover at the location of each of the arches. Each of the hold-down ends is secured in relief to the arch itself, that is, at or near the ground level, with some space between the end of the hold-down and the arch. The hold-down end may be secured by means of a tent stake or, if the arches are inserted into retaining means in the ground, may be attached to the retaining means itself, by means of a hook or other attachment means. The hold-down presses down on the cover material and holds it in the concave groove present in each arch.

The cover is preferably a clear plastic film, such as a polyvinyl, that allows the greatest amount of sunlight onto the plants beneath the cover. The plastic film may be polarized to selectively filter out or enhance certain spectra of light. It is known that certain plants thrive in the presence of certain light spectra. Tomatoes, for example thrive in the presence of infrared light. A cover according to the invention with an intended use for tomatoes would ideally be polarized to enhance the infrared light and to screen out or retard the pass-through of certain spectra of light that are known to be undesirable.

The manner in which the cover of the present invention is secured gives rise to a number of benefits. Because of the elastic nature of the hold-down of the cover, and because of the small space at or near ground level between the hold-down and the arch, it is trivial to push the edge of the cover up to gain access to the plants and then to push the cover back down again after the need for access is over. Unlike the prior art, the hold-downs do not need to be undone, detached, or loosened in order to gain access to the plants or, in general, to expose the plants to the ambient conditions to any degree, such as, for example, to vent the interior atmosphere for temperature or humidity control reasons. Furthermore, simply draping the cover over the arches and using the hold-downs according to the invention to secure the cover eliminates the localized stresses on the cover that are present in most traditional row cover systems, in which the cover is fastened directly to the support. The cover according to the invention also eliminates the tedious chores of placing hold-down weights along the edges of the cover and then of moving them when lifting or dropping the lower edges of the cover.

The use of the elastic hold-downs and the method of securing the hold-downs to the ground or to a retainer means, rather than to the arches themselves enables the use of multiple covers or of compound covers. This is helpful for many reasons. For example, it may be desirable to have a heavy cover and a light cover, the former placed on top of the later. During periods of high risk of frost, or other extreme conditions, the heavy cover will be completely deployed. The layer of air between the two covers provides a layer of insulation against frost. During more moderate conditions, and when no frost is reasonably expected, lower side portions of the heavy cover may be slid up and bunched up toward the top of the arches, leaving the light cover to protect the plants from birds and insects. Alternatively, the light cover may be made of mesh, so that air freely flows through it when the heavy cover is stowed at the top of the arches. In this mode of operation, one may choose a mesh material that vents heat and moisture while continuing to exclude insects and birds. The heavy cover is impervious to air and water and is lowered in anticipation of extreme conditions such as frost. Although the discussion here is of using two covers, it is understood that any number of covers may be draped over the arches, depending on the particular geographic conditions. As yet another alternative, the system may use a compound cover that comprises a central upper portion that is clear vinyl and lower side portions that are a mesh material, or a cover in which a heavy cover is attached to lower side portions along with the mesh material in such a manner that the heavy cover overlays the mesh side portions and may be lifted above the mesh portions, as desired.

The present inventor has found through experimentation, in which plants were grown within and without row covers of the type covered by the invention, that plants inside the cover benefit not just from protection against the frost, but also protection from other environmental factors, presumably stress from wind, rains, and insects. This is known since, even in the absence of early frost during the test, those plants growing within the cover matured days, even weeks, earlier than those growing immediately outside under conditions that were as identical as the inventor could make them.

### BRIEF DESCRIPTION OF THE DRAWINGS

FIG. 1 is a perspective view of the invention.

FIG. 2 is a side view of the invention.

FIG. 3 is an end view of the invention.

FIG. 4 is a detailed view of the elastic line in conjunction with a support arch in the First embodiment of the invention.

FIG. 5 shows details of a compound cover as configured in a first embodiment of the invention.

FIG. 6 shows the first embodiment configuration with the outer portion of the lower compound cover pushed up to allow venting of the enclosure.

FIG. 7 shows the first embodiment configuration with the entire lower portion of the compound cover pushed up to allow access to the plants within the enclosure.

FIG. 8 is a partial plane elevational view of the Preferred Embodiment of the garden cover according to the invention, showing the retaining means to secure the hold-down.

FIG. 9 is a cross-sectional view of the Preferred Embodiment of the support arch according to the invention.

### DETAILED DESCRIPTION OF THE INVENTION

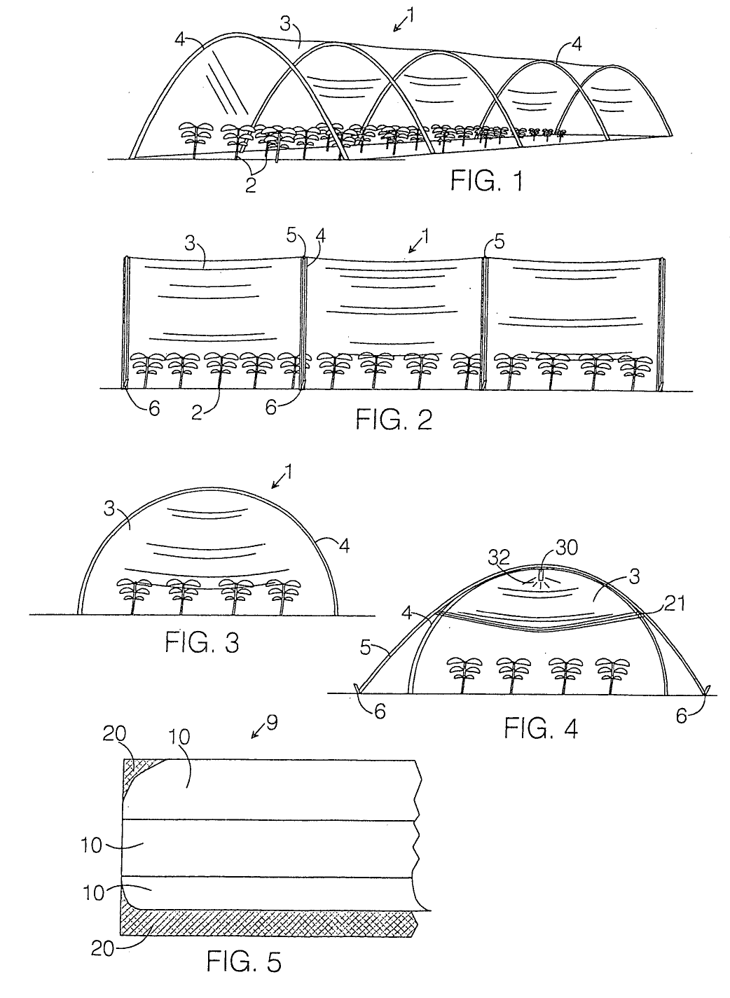

FIGS. 1-4 illustrate a first embodiment of a protective enclosure 1 deployed over and along several rows of garden plants 2. The protective enclosure 1 comprises in major part a clear plastic cover 3 draped over a plurality of arch supports 4. As shown, at each of the arch supports 4, the cover 3 is pressed down onto the support by a hold-down 5, which in the first embodiment is an elastic cord. With continuing reference to FIG. 1, it can be seen that the hold-down 5 is affixed to the ground by a hold-down stake 6, which in the first embodiment is simply a miniature tent stake.

FIG. 5 illustrates a first embodiment of the cover 3, which is a compound cover 9 comprising a base layer 10 and two side panels 20, The base layer 10 is a plastic sheet that is impervious to wind and rain. The side panels 20 are sewn along the sides of the base layer 10. The side panels 20 are constructed of a mesh material and prevent the passage of insects and birds into and allow air and moisture to pass freely from the atmosphere outside of the protective enclosure 1. In this first embodiment, the base layer 10 defines the area and limits of the compound cover 9 and extends down over the side panels 20, as shown. The side panels 20 extend approximately one-third of the way up the side of the compound cover 9, which is draped over the arch supports with the side panels 20 facing the inside of the protective enclosure 1.

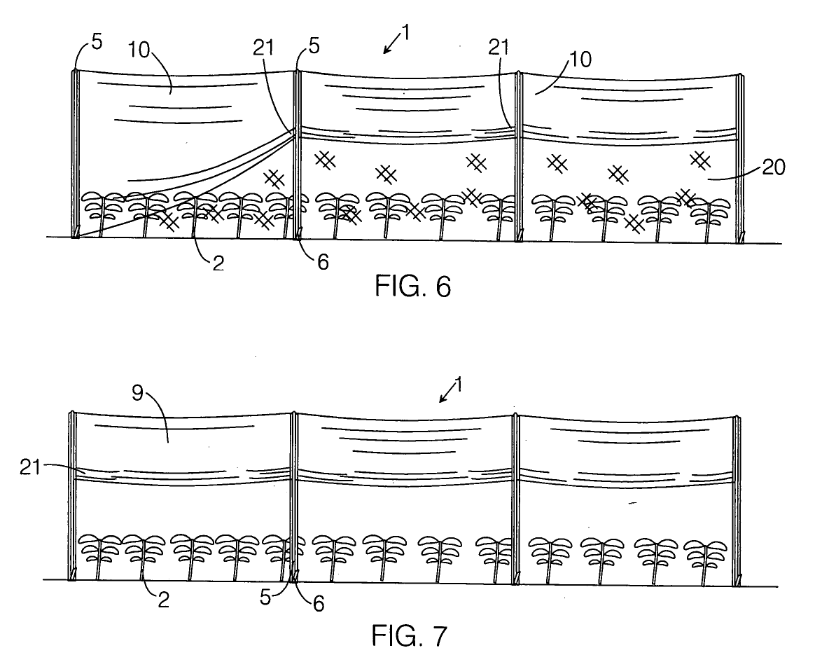

In use, the protective enclosure 1 is erected over the rows to be protected after the garden has been planted. In general, the garden will be planted and the protective enclosure 1 will be put in place on or before the date of the average final Spring frost, and is meant to protect against frost, though not an extended hard freeze. During the first part of the season, the compound cover 9 will be arranged so that the ventilation panels 20 are covered by the base layer 10. Nevertheless, even during the early part of the season, on particularly mild days, one may decide to bunch the lower part of the base layer 10 up under the hold-down 5 so that air can pass through each hold-down 5 and onto the plants, as shown in FIG. 6. As the season advances, the configuration depicted in FIG. 6 will become the default configuration, with the protective enclosure 1 moved to its more protective mode only when high winds, rain, or a rogue frost is anticipated.

For those times that the gardener needs to tend directly to the plants 2, or desires natural pollination of the plants by insects or birds, the entire compound cover 9 is bunched up under the hold-down 5, forming a bunched-up portion 21, all as depicted in FIG. 7. Because of the tension in the hold-down 5, sufficient frictional forces are generated to hold the bunched-up portion 21 in place, without need for continuous intervention by the gardener. And yet, that frictional force is not so great as to interfere with the gardener's pulling down the ventilated panels 20 after the desired procedure with the plants 2 is complete.

The first embodiment also includes means for delivering mist to the plants 2 within the protective enclosure 1. This is shown in FIG. 8.

FIG. 8 illustrates a partial frontal plane view of a Preferred Embodiment of a protective enclosure 100 according to the invention. The protective enclosure 100 comprises the cover 3, the arch supports 4, the hold-downs 5 described above, plus a retaining means 110 for securing the arch support 4 in the ground and the hold-downs 5 to the retaining means 110. The protective enclosure 100 is deployed generally as shown in FIG. 1, with a series of arch supports 4 and hold-downs 5. One retaining means 110 is placed in the ground G along each side of the row of plants, at each location where it is intended to install the arch support 4. The retaining means 110 is ideally a hollow tube that is placed deep enough in the ground that it is securely anchored. Each arch support 4 has two support ends 4A and each hold-down has two hold-down ends, each end with a first fastener 5A. In the Preferred Embodiment, the support ends 4A and the first fasteners 5A are secured by the retaining means 110. The support ends 4A are inserted into the retaining means 110 as shown. Generally, the spring force of the arch support 4, when both support ends 4A are secured in respective retaining means 110, will keep the arch support 4 from springing loose. It is within the scope of the invention, however, to provide an additional positive means of anchoring each end 4A, such as a pawl over which the end 4A snaps, etc. The first fasteners 5A are releasably attachable to a second fastening means 112 provided on the surface 110A of the retaining means 110. In this Preferred Embodiment, the first fastener 5A is a loop or eye and the second fastener is a hook that is securely attached to or integrated into the construction of the retaining means 110.

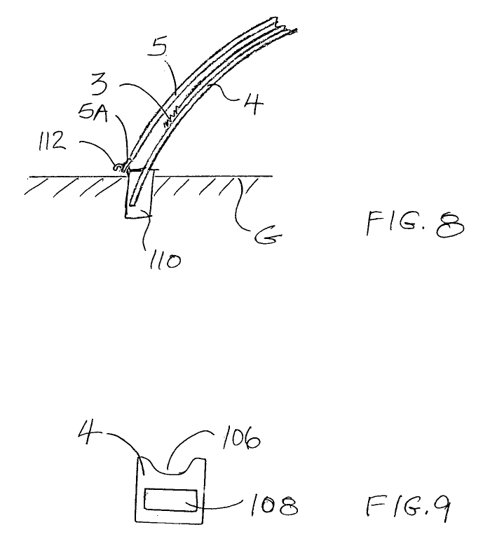

FIG. 9 shows a cross-sectional view of the Preferred Embodiment of the arch support 4, which has a groove 106 on a first side. The arch support 4 is installed so that the groove faces away from the cover 3. The groove 106 and the hold-down 5 are sized such that at least a portion of the circumference of the hold-down 5 is restrained within the groove 106, to prevent the hold-down 5 from moving laterally. Optionally, the arch support 4 is a PVC extruded element that also has a channel 108 on a second side that extends the length of the element. The channel 108 aids in diffusing heat from the arch support 4, reduces the amount of material required to manufacture the element and, therefore, reduces its cost. The arch support 4 is shown in the drawings as a single element. It is also possible to provide the arch support 4 as a plurality of sectional elements that connect to each other. Suitable connection means include interference fit, a pawl-and-recess fastener, a snap lock. These connection means are given by way of example and are in no way limiting of the scope of the invention. Providing sectinal elements for assembling the arch support 4 offers advantages for shipping and transport, and also allows the user of the protective enclosures 1 or 100 to adjust the length of the arch support 4 to accommodate various desired widths of plant rows.

The cover 3, at least an upper central and lengthwise portion of the cover, is preferably made of a clear plastic, such as a polyvinyl. The vinyl material is durable, allowing the cover to be used year after year, thereby reducing the annual cost of the enclosure. A clear plastic allows the greatest amount of light to pass through to the plants below. The clear plastic material may also be polarized, to enhance the pass-through of desirable spectra of light through the cover and/or to retard or screen out the passage of undesirable spectra.

Although the details of particulars embodiment of the present invention have been set out above, there is no intention to thereby limit the scope of the invention. It is understood that a person skilled in the art will be able to envision numerous other variations and embodiments that are encompassed within the scope of the invention as claimed.

1. A protective enclosure for a row of garden plants sewn in the soil out-of-doors, said enclosure comprising:
a plurality of support arches for spanning and extending along said row in a plurality of arch positions, each one support arch of said plurality of support arches having a first support end and a second support end,
a cover drapable over said plurality of semi-circular arches;
a plurality of hold-downs, each hold-down of said plurality of hold-downs having a first hold-down end and a second hold-down end; and
a plurality of retaining means, anchorable in a ground surface;
wherein said each hold-down is extendable over said cover at said arch, so as to hold said cover on said support arch;
wherein a first retaining means and a second retaining means of said plurality of retaining means are anchorable in said ground surface such that said hold-down end is attachable to said first retaining means and said second hold-down end is attachable to said second retaining means, said hold-down end being attachable to said retaining means in a manner that leaves a small space between said hold-down end and said support arch, thereby allowing a lower portion of said cover to be bunchable up between said hold-down and said arch, without having to manipulate said hold-down.

2. The enclosure of claim 1, wherein said cover is a compound cover comprising a central lengthwise portion of a plastic fabric and two lengthwise side portions.

3. The enclosure of claim 2 wherein said side portions are constructed of a mesh fabric.

4. The enclosure of claim 2, wherein said central lengthwise portion is constructed of a clear vinyl film.

5. The enclosure of claim 2, wherein each side portion of said two lengthwise side portions is a dual cover, having an undercover of a mesh fabric and an overcover of a solid fabric.

6. The enclosure of claim 1 wherein said cover includes two or more layers of sheeting that is drapable over said plurality of arch supports.

7. The enclosure of claim 1, wherein said hold-down end has a first fastening means and said retaining means has a second fastening means, such that said hold-down is anchorable on said first retaining means and said second retaining means.

8. The enclosure of claim 7, wherein said retaining means is a hollow tube that is anchorable in said soil.

9. The enclosure of claim 8, wherein said first arch end is insertable in said first retaining means and said second arch end insertable in said second retaining means.

10. The enclosure of claim 1, wherein said support arch comprises a plurality of support arch sections that fit together.

11. The enclosure of claim 1, wherein said hold-down is an elastic cord that is stretchabel over said support arch.

12. The enclosure of claim 1, wherein said first arch end is insertable into said soil on a first side of said row and said second arch end is insertable into said soil on a second said of said row.

13. The enclosure of claim 1, wherein said hold-down is made of elastic material and of such a length that said hold-down must be stretched in order to extend between said first arch end and said second arch end while passing over said cover.

14. The enclosure of claim 1, wherein said cover has at least a central portion that is made of a clear plastic film.

15. The enclosure of claim 1, wherein said cover has at least a central portion portion that is made of a polarized plastic film.
